(19) United States
(12) Patent Application Publication
(10) Pub. No.: US 2012/0303276 A1
(43) Pub. Date: Nov. 29, 2012

(54) SCOUR MONITORING SYSTEM

(75) Inventor: Joseph Raymond BOWER, Enola, PA (US)

(73) Assignee: GANNETT FLEMING, INC., Camp Hill, PA (US)

(21) Appl. No.: 13/114,239

(22) Filed: May 24, 2011

(51) Int. Cl. G06F 19/00; G01N 17/00

(52) U.S. Cl. 702/2; 73/86

(57) ABSTRACT

An apparatus and method for the monitoring of scour in a streambed at a site. The apparatus has a support member and at least one float sensor attached to the support member. The at least one float sensor is buried in the streambed and has a switch device, with the switch device being movable between a first position and a second position. As a scour event occurs which causes the streambed to be eroded beyond the at least one float sensor, the at least one float sensor will rise causing the switch device to be moved from the first position to the second position.

### FIELD OF THE INVENTION

The present invention relates to scour monitoring systems. Specifically, the present invention relates to a scour monitoring system which can be used with new or existing structures, including bridge piers, abutments, walls, platforms, and the like.

### BACKGROUND OF THE INVENTION

Scour is the result of the erosive action of flowing water, excavating and carrying away material from the bed and banks of streams. Naturally, not all materials scour at the same rate, which makes the predictability of scour very difficult. This phenomena typically occurs in stream and river bottoms during periods such as heavy rainfalls and spring runoffs. The result can sometimes be cavities having depths twice that of the water depth. Unfortunately, while the evidence of scour is obvious during its occurrence, as water levels recede and flow conditions return to normal these cavities often refill making detection difficult. These difficulties in prediction and late detection of scour have led to the necessity of monitoring sites for the occurrence of scour.

Equipment used for scour observations has usually been quite simple: sounding rods for shallow flows and lead sounding weights on a line for deeper flows. Both of these devices were developed to sound for navigation depths hundreds of years ago, and were adapted for depth soundings in connection with stream flow measurements during the 19th century. The main adaptations involved streamlining the sounding weights and using stay lines or vertically supported sounding rods so that the weights or rods would not be swept downstream in high velocities.

Eventually, these crude devices gave way to more advanced equipment. In the 1950's significant advances were made in sonar, sonic sounders, electronic positioning equipment, and radar. There were problems with these techniques, however. Accuracy, flow depth restrictions, and perhaps most importantly since many existing bridges are maintained by small local authorities, high cost—all acted as significant disadvantages of these devices. For example, sediment concentration along some streams or rivers is so high that the standard sonic sounders cannot distinguish between the moving sediment and the non-moving bed. U.S. Pat. No. 4,855,966 to Cinquino shows one particular sonic device wherein a housed probe descends within a scour hole, and a bridge mounted sonic transducer operates to determine the distance of the probe from a reference point on the bridge.

Another technique, as shown in U.K. Patent Application No. GB 2245736 to Waters, uses buried omni-directional mercury switches. As scour occurs and the switches are unburied, the water flow causes these switches—of which there are only three—to actuate sending a signal to a bridge mounted monitor. The installation of this device is very delicate and cannot be merely driven into the stream bed like the present invention. Instead, a large area of the bed must be dug up, and then refilled after insertion of the Waters' unit. Disturbing the stream bed in this fashion actually increases the area's susceptibility to scour. The Waters device is also relatively expensive due in part to the installation process.

Another device, known only to have been used in New Zealand as long ago as 1982, employed a radioactive source housed within a large lead weight. This device is described in the printed publication entitled “Field Measurement Of Scour Depth Using A Portable Gamma Spectrometer” by B. W. Melville, and submitted as Report No. 287 to the Department of Civil Engineering at the University of Auckland, in Auckland, New Zealand. In Melville's device a gamma-ray probe was used to determine the location of a radioactive material (Cobalt 60) contained within the lead weight as it sank into a scour hole. It is believed that the general U.S. population would look unfavorably on the use of radioactive material in their various water supplies.

Still another device, as shown in U.S. Pat. No. 5,532,687 to Richardson et al., is directed to a modular scour monitoring device which employs magnets located within a weighted descending collar is designed for placement about bridge piers, abutments and the like, such that the occurrence of scour causes descent of the collar. This descent is monitored against the initial reference point using one of two systems: a magnetic detecting probe unit or a magnetic switch array. The probe unit utilizes a graduated cable with a magnet detector mounted at one end and a signaling device at the other. The switch array system employs electrical components which are selectively activated with the descent of the collar, permitting periodic readings of the arrays various electrical properties to reveal the new depth.

While the systems disclosed in the prior art provide information regarding scour, the prior art suffers from one or more of the following: problematic installation on or near a new or existing bridge pier or abutment; an inability to obtain scour depth readings from above the water or from a remote site; an inability to operate during storm and flood conditions; an inability to operate in a range of flow conditions; an inability to withstand ice and debris; high relative cost; an ability to perform reliably when scour occurs; and an ability to be operated and maintained by highway maintenance personnel. It would, therefore, be beneficial to provide a scour monitoring system which could overcome the disadvantages of the prior art.

### SUMMARY OF THE INVENTION

One exemplary embodiment discloses an apparatus for the monitoring of scour in a streambed at a site. The apparatus has a support member and at least one float sensor attached to the support member. The at least one float sensor is buried in the streambed and has a float device and a switch device, with the switch device being movable between a first position and a second position. As a scour event occurs which causes the streambed to be eroded beyond the at least one float sensor, the at least one float sensor will rise causing the switch device to be moved from the first position to the second position.

In an exemplary embodiment the apparatus may include a data system to store data received from the switch device. A communications device may also be provided to communicate a signal when the switch device is moved to the second position.

In an exemplary embodiment the support member is a conduit, pipe or other rigid member which has an anchor mounted thereto at an end which is buried in the streambed. A first portion of the conduit may be buried substantially in said stream bed and a second portion of the conduit may extend to the data device.

In an exemplary embodiment the at least one float sensor includes multiple float sensors which are attached to and spaced apart at periodic intervals on the support member, whereby the amount or depth of scour can be determined by directly relating the known switch devices of the float sensors installation elevations to the switch devices which have been moved to the second position.

In an exemplary embodiment alarms are provided to alert when conditions of measurable scour are present, the conditions of measurable scour being predetermined based on parameters of the site.

In an exemplary embodiment a power source provides the power required for the apparatus.

In an exemplary embodiment the at least one float sensor is initially maintained in position relative to the support member by a releasable positioning device.

One exemplary embodiment discloses a system for the monitoring of scour in a streambed at a site. The system has at least one sensor which is moveable from a first position and a second position. The at least one sensor being buried in the streambed and has a switch device which is movable from an armed position to a triggered position. The system also has a data system with a communications device. The data system receives information from the at least one sensor. The communication device communicates when the switch device of at least one sensor is moved from the armed position to the triggered position, such as when a scour event occurs which causes the streambed to be eroded beyond the switch device of the at least one sensor will be moved to the triggered position.

One exemplary method for monitoring scour within a streambed discloses the steps of: maintaining at least one float sensor in a first position relative to a portion of a support member by a positioning device; burying the portion of the support member and the at least one float sensor in the streambed; releasing positioning device to allow the float sensor to move relative to the support member, thereby allowing the float sensor to move as scour occurs to the streambed; moving a switch of the at least one float sensor to a triggered position as the at least one float sensor is moved to a second position; and communicating the movement of the switch to the triggered position, thereby communicating a condition of measurable scour.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a diagrammatic view of an exemplary embodiment of a scour monitoring system illustrating the initial positioning of the system in relation to a bridge pier, a bridge foundation, a stream/river bed and water of the stream/river.

FIG. 2 is a diagrammatic view of the exemplary embodiment of the scour monitoring system shown in FIG. 1 illustrating several sensors activated during an event in which scour occurred.

FIG. 3 is an enlarged view of a retention system for maintaining the scour monitoring system in the initial position as the scour monitoring system is installed.

Wherever possible, the same reference numbers will be used throughout the drawings to represent the same parts.

### DETAILED DESCRIPTION OF THE INVENTION

There are many bridges and structures upon which the effects of scour can case the bridge or structure to become unsafe or fail. In general terms, scour is the erosion of a streambed or bank material due to flowing water. With limited funds available, these bridges and structures cannot all be replaced or repaired to eliminate potential scour threats. Therefore, the bridges and structures must be monitored during conditions, such has heavy rains and floods, which tend to accelerate scour to determine the amount and extent of scour that occurs. In order to effectively monitor the structures, scour monitoring systems, such as scour measuring fixed instrumentation, are provided proximate the structure. The scour monitoring systems must be: capable of being installed on or near a bridge pier or abutment; able to obtain scour depth readings from above the water of from a remote site; operable during storm, flood and other extreme conditions; capable of operating in a wide range of flow conditions; capable of operating in conditions of ice and debris; operable and maintainable by highway maintenance personnel; and installed and operated at a relatively low cost. The scour monitoring system 50 shown and described in the exemplary embodiments accomplishes all or many of the recited criteria.

The scour monitoring system 50 as shown and claimed herein is a fixed instrumentation system in which a portion of the scour monitoring system 50 in which a portion is buried in a river or streambed 22, as will be more fully discussed. The term stream as used herein is defined as a body of water that may range in size from a large river to a small rill flowing in a channel, whether such body of water is a natural channel or drainage course formed by flowing water, whether such is occupied by water or not.

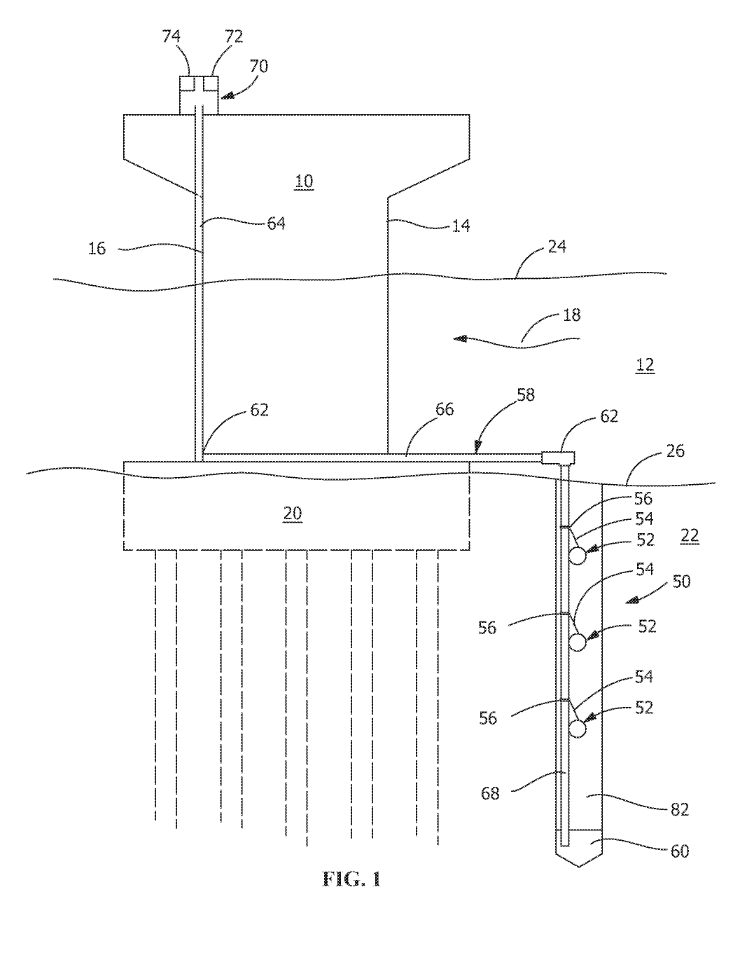

Referring to the exemplary embodiment shown FIG. 1, a bridge pier 10 is shown positioned in a stream 12. The bridge pier 10 has a front side 14 and a back side 16. The front side 14 is positioned to encounter the predominant flow, as indicated by arrow 18, of the stream 12. The back side 16 of the pier 10 is somewhat sheltered as compared to the front side 14, as the back side 16 is not in the direct path of the predominant flow 18 of the stream 12. A foundation 20 extends downward from the pier 10 into the streambed 22. Depending upon the characteristics of the streambed 22 and the flow conditions of the stream 12, including, but not limited to, the nominal stream level 24, the nominal bed elevation 26 and the 100-year and possibly 500-year flood characteristics, the depth of the foundation will vary in order to provide the structural integrity required. As the science of designing foundations is well known, a further explanation is not deemed necessary.

As best shown in FIG. 1, an exemplary scour monitoring system 50 is shown. The scour monitoring system 50 include a number of float sensors 52 which are buried in the streambed 22 proximate the foundation 20, as will be more fully described. The float sensors 52 are self-contained buoyant devices which contain an internal bi-state positional gravity switch. This gravity switch, a part of float sensor 52, tends to switch to a first position when positioned cable up and to a second position when positioned cable down. These float sensors are connected electrically and mechanically to a strong, flexible cable 54. This cable 54 enters a conduit 58 at a hole 56 which provides strain relief and fixes the cable length. Examples of float sensors include, but are not limited to Series FSW Free-Float Level Switches manufactured by W.E. Anderson, Submerged Float Switches manufactured by F.A.E.S., Tilt Flow Switches manufactured by Madison Co., and Cable Float Switches manufactured by W.E. Anderson.

The float sensors 52 are attached to or mounted to conduit 58 at variable or, alternatively, periodic intervals. The spacing of the float sensors 52 may be configured according to the environment and the conditions being monitored. In representative exemplary applications the float sensors 52 may be spaced apart by 1 foot, while in other representative exemplary applications the float sensors 52 may be spaced apart by 5 feet or more.

Support member or conduit 58 has an anchor 60 mounted thereto at the end which is positioned below the streambed 22. The anchor 60 can be of any material that has the required weight characteristics. Conduit 58 extends from the anchor 60 toward a surface or deck supported by the pier 10. In the exemplary embodiment shown, the conduit has two bends or elbows 62 which allow a first portion 64 of the conduit 58 to be positioned proximate the back side 16 of the pier 10, thereby sheltering the first portion 64 from debris and the like which may be carried by the predominant flow 18 of the stream 12. A second portion 66 of the conduit 58 is positioned proximate to and essentially parallel to a top surface of the foundation 20. The positioning of the second portion 66 minimizes the likelihood that debris or rolling boulders will cause the second portion 66 of the conduit 58 to fail. A third portion 68 of the conduit 58 is essentially perpendicular to the second portion 66, such that the third portion 68 extends into and below the nominal bed elevation 26. The float sensors 52 are mounted on the third portion 68. Many other configurations and numbers of elbows and portions may be provided without departing from the scope of the invention.

The overall shape of the conduit 58 is designed to be low profile to minimize the intrusion of the conduit 58 in the stream 12 and minimize the conduit's 58 impact to the flow. The conduit 58 is a hollow piping which allows wires or other signal transmission means to be connected to the float sensors 52. The conduit 58 may be may be made from rigid material, including, but not limited to, steel, stainless steel, aluminum, plastic covered steel and the like. As not all bridges and piers are identical, the particular configuration and the placement of the conduit 58 may vary according to the particular application.

Conduit 58 is connected to a data system 70 which is positioned proximate the surface which is supported by the pier 10. The data system 70 allows for access to the information related to the scour monitoring system 50 to facilitate the maintenance, repair and monitoring by roadway crews, thereby limiting the necessity of specially trained personnel and special equipment (e.g. underwater bridge inspection cranes, scaffolds, and the like). The data system 70 may be any type of microcontroller or data logger 72 which can display, record and/or store data and which are reliable in the environmental conditions in which it is located. In addition, specially constructed systems may also be used for logging scour data from the scour monitoring system 50. The data system 70 stores the collected data, such as the when the float sensors 52 have been moved to the tripped position. The relevant data may be saved for later recovery, displayed on a monitor or other device, printed out with date and time stamps, or transmitted remotely for other use.

The data system 70 may have a communications device 74. The data communication device 74 may be in the form of wired or wireless device which communicates with a remote location by means of light transmission, radio frequency (RF) transmission, satellite transmission and/or telephone transmission to transmit data between the remote bridge site and a remote location such as a central office or the like. This allows the scour monitoring system 50 to be controlled and interrogated remotely and allows the scour monitoring system 50 to transmit information to the remote location. In other words the communication device 74 not only allow engineers or other personnel to communicate with the scour monitoring system 50, but also allows for the scour monitoring system 50 to freely communicate with a central office or the like. This type of communications technology is known and is relatively simple to implement, and its utilization and setup would be well understood by those skilled in the relevant field.

With these scour monitoring system 50 it may be necessary to employ means and methods which will alert personnel of critical scour conditions both remotely and on site. Audible alarms, such as bells, whistles, alarms or the like, and/or visual alarms, such as light sources may be hooked into the system to warn of exceeded threshold levels. These threshold values may be predetermined based on the various parameters of the monitored site. Additionally, at the bridge site automated crossing guards may be activated in such emergencies so that a critical bridge would be blocked off from traffic. Naturally, combinations of these alerting signals may be used on and off site.

In order to power the scour monitoring system 50, including the data system 70 and/or the communication device 74, alternating current or direct current power sources may be supplied. This sources may include, electric utility services, photovoltaic cell-powered sources with battery backups or other types of self contained power sources which can be used in remote locations. Implementing these devices is within the knowledge of those skilled in the art.

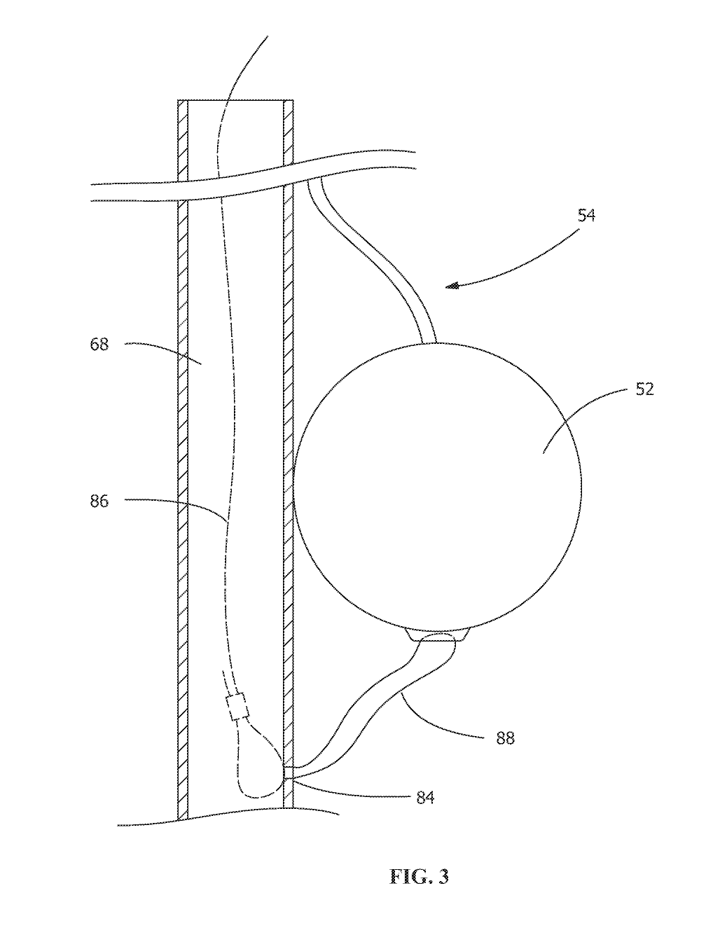

As previously described, the scour monitoring system 50 includes a number of float sensors 52 that are initially buried among material which comprise the streambed 22 (e.g., without limitation, soil, rocks, gravel, silt, and/or other filler materials) at a location generally at or near a portion of the bridge pier 10. The float sensors 52 and third portion 68 of the conduit 58 may be buried during initial construction of the foundation 20 and/or pier 10 or may be buried at a later time as desired. The general size and shape of each of the float sensors 52, generally provides for such retrofitting to existing structures to be commonly carried out through the use of a hollow stem/core auger or other suitable device. The float sensors 52 are initially buried in an inactive or armed position. As best shown in FIG. 3, the float sensors 52 are maintained in the inactive or armed position by a positioning device or member, such as sacrificial material loops 88 which connects to a release cable 86 through openings or holes 84 of the conduit 58 which maintain the floats in the initial position. In some embodiments seals may be provided in openings 84 through which the sacrificial string loops 88 may extend. Alternatively, the float devices 54 may be maintained in the armed or initial position by means of other mechanical members, such as pins, by adhesives which are dissolvable when exposed to water or by other means known in the industry.

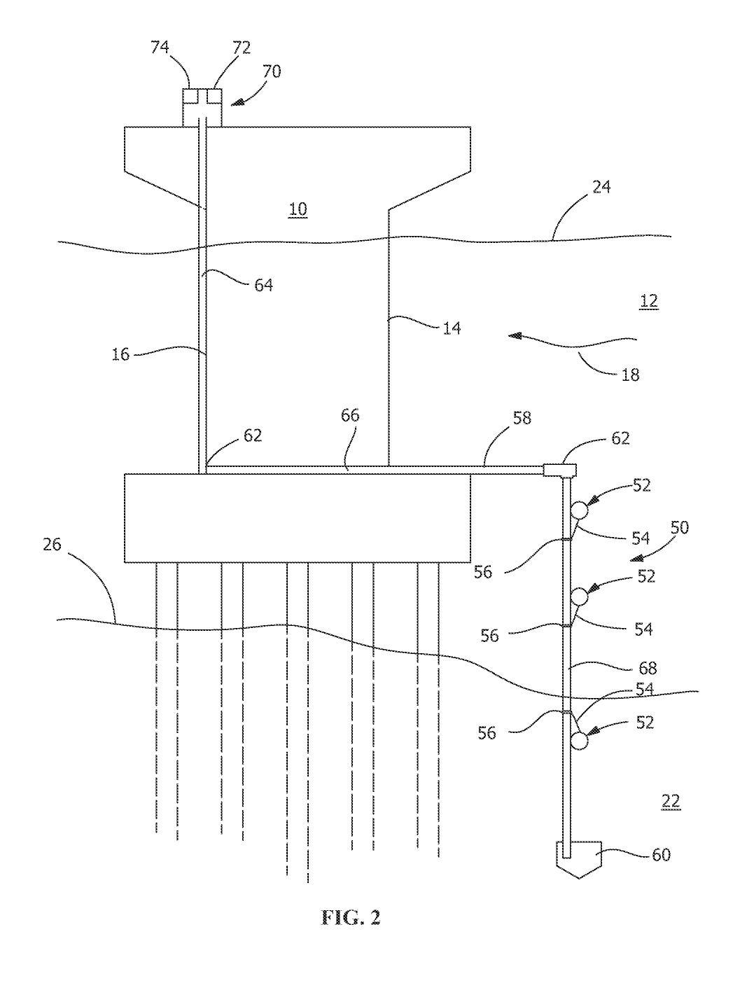

Once the float sensors 52 and third portion 68 of the conduit 58 are properly positioned in the channel or opening 82 (FIG. 1) created by the auger, the channel 82 is backfilled with the material removed by the auger during the creation of the channel, as represented in FIG. 2. Alternatively, the channel 82 may be filled with other material having scour characteristics similar to that of the streambed 22. With the channel 82 properly backfilled, the release cable 86 is withdrawn, breaking the sacrificial material loop 88 from the float sensors 52, allowing the float sensors 52 to move independently of the release cables 86 as needed, i.e. allowing the float sensors 52 to move to an active or tripped position once reoriented from the armed position as a result of being unburied due to scour. The release of the sacrificial material loop 88 may be done by a mechanical mechanism or may be done by other means. Each float sensor 52 has its own release cable 86, however, other configurations, such as, but not limited to, release cables 86 cooperating with alternate float sensors 52, can be used without departing from the scope of the invention.

The float sensors 52 are generally sufficiently buoyant such that when unburied, due to scour, the float sensors 52 will rise and attempt to float to the surface of the stream 12. As shown in FIG. 2, each float sensor 52 will go from a buried, armed position (shown in FIG. 1) to a floating, triggered position (shown in FIG. 2) when the original soil level is scoured away to a new scour level below the original location of the respective buried float sensor 52.

As is best shown in FIG. 2, as each of the float sensors 52 and their integral gravity switches becomes unburied due to scour and floats toward the surface of water, the float sensor 52 is moved from the armed, initial position to the tripped, second position, thereby sending an appropriate signal through the conduit 58 to the data system 70. The number of float sensors 52 activated is dependent upon the depth of scour. Therefore, during a scour event, the depth of scour that actually occurs can be easily determined. By knowing the installed elevation or position of each float sensor 52, the depth of scour can be inferentially determined. In other words, the amount of scour can be determined by relating the known float sensor installed positions with the detected signals from the number of switch devices of the float sensors 52 which have been moved to the second position.

In one exemplary embodiment, the plurality of float sensors 52 form an array preferably connected in parallel. Each float sensor 52 mat be further connected an electrical component, such as, but not limited to a resistor, capacitor, or the like for the purpose of configuring a fail-safe, monitored circuit. As successive float sensors 52 are tripped or moved to an activated position, the electrical component connected to each tripped float sensor 52 is monitored thereby avoiding false signals resulting from broken cables.

When initially buried in initial orientation, the scour monitoring system 50 is preferably in a powered down or nearly powered down state in order to conserve power. When the float sensors 52 are released causing their integral switches to move to the tripped position, the scour monitoring system 50, including the communication device 74, is power up and becomes active. Once tripped, the float sensors 52 send signals to the data system 70. The data system 70 interfaces with the communications device 74 to transmit the signal, as previously described.

While the designs and concepts disclosed herein focus upon and may find use for the monitoring of bridge scour, they may also obviously find use in a wide variety of other applications. Accordingly, the scope of protection is directed to detecting scour near a structure or support element, such as bridge abutment located in a body of water, whether such body of water is permanent or temporary. The support element may, for example, without limitation, be a portion of a bridge, dam, or any other structure located over, through or near a body of water or other similar application where scour or similar process is of potential concern. It should therefore be understood, that while the field of application of the invention is discussed in a limited concept, the scope of protection afforded is not intended to be so limited.

Accordingly, it is to be appreciated that the present invention provides a robust, cost-effective monitoring system and sensors that utilizes simple physical principles to detect scour and alert of its presence.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for the monitoring of scour in a streambed at a site, the apparatus comprising:
a support member;
at least one float sensor attached to the support member, the at least one float sensor being buried in the streambed, the at least one float sensor having a switch device, the switch device movable between a first position and a second position;
wherein as a scour event occurs which causes the streambed to be eroded beyond the at least one float sensor, the at least one float sensor will rise causing the switch device to be moved from the first position to the second position.

2. The apparatus for the monitoring of scour as described in claim 1, wherein a data system is provided to display or store data received from the switch device.

3. The apparatus for the monitoring of scour as described in claim 2, wherein a communications device is provided to communicate a signal when the switch device is moved to the second position.

4. The apparatus for the monitoring of scour as described in claim 2, wherein the support member is a conduit which has an anchor mounted thereto at an end which is buried in the streambed.

5. The apparatus for the monitoring of scour as described in claim 4 wherein a first portion of the conduit is buried substantially in said stream bed and a second portion of the conduit extends to the data device.

6. The apparatus for the monitoring of scour as described in claim 1, wherein the at least one float sensor are multiple float sensors which are attached to and spaced apart on the support member, whereby the amount of scour can be determined by relating the known float sensor installed positions with the detected signals from a number of switch devices which have been moved to the second position.

7. The apparatus for the monitoring of scour as described in claim 1, wherein alarms are provided to alert when conditions of critical scour are present, the conditions of critical scour being predetermined based on parameters of the site.

8. The apparatus for the monitoring of scour as described in claim 1, wherein a power source provides the power required for the apparatus.

9. The apparatus for the monitoring of scour as described in claim 1, wherein the at least one float sensor is initially maintained in position relative to the support member by a releasable positioning device.

10. A system for the monitoring of scour in a streambed at a site, the system comprising:
at least one sensor being moveable from a first position and a second position, the at least one sensor being buried in the streambed, the at least one sensor having a switch device which is movable from an armed position to a triggered position;
a data system having a communications device, the data system receiving information from the at least one sensor, the communication device communicating when the switch device of the at least one sensor is moved from the armed position to the triggered position;
wherein as a scour event occurs which causes the streambed to be eroded beyond the switch device of the at least one sensor will be moved to the triggered position.

11. The system for the monitoring of scour as described in claim 10, wherein the data system has a data logger to store data received from the switch device.

12. The system for the monitoring of scour as described in claim 10, wherein the communications device is provided to communicate a signal to a remote location when the switch device of the at least one sensor is moved to the triggered position.

13. The system for the monitoring of scour as described in claim 10, wherein the at least one sensor are multiple sensors which are attached to and spaced apart on a support member, whereby the amount of scour can be determined by relating the known float sensor installed positions with the detected signals from a number of switch devices which have been moved to the second position.

14. The system for the monitoring of scour as described in claim 13, wherein the multiple sensors are float sensors.

15. The system for the monitoring of scour as described in claim 14, wherein the support member is a conduit which has an anchor mounted thereto at an end which is buried in the streambed.

16. The system for the monitoring of scour as described in claim 10, wherein alarms are provided to alert when conditions of critical scour are present, the conditions of critical scour being predetermined based on parameters of the site.

17. The system for the monitoring of scour as described in claim 10, wherein a power source provides the power required for the apparatus.

18. The system for the monitoring of scour as described in claim 10, wherein the at least one sensor is initially maintained in position relative to a support member by a releasable positioning device.

19. A method for monitoring scour within a streambed comprising the steps of:
maintaining at least one float sensor in a first position relative to a portion of a support member by a positioning member;
burying the portion of the support member and the at least one float sensor in the streambed;
releasing positioning member to allow the float sensor to move relative to the support member, thereby allowing the float sensor to move as scour occurs to the streambed;
moving a switch of the at least one float sensor to a triggered position as the at least one float sensor is moved to a second position;
communicating the movement of the switch to the triggered position, thereby communicating a condition of scour.

20. The method as described in claim 19, wherein the at least one float sensor are multiple float sensors which are attached to and spaced apart at periodic intervals on the support member, whereby the amount of scour can be determined by relating the known float sensor installed positions with the detected signals from a number of switch devices which have been moved to the second position.
